(19) United States
(12) Patent Application Publication
(10) Pub. No.: US 2026/0271157 A1
(43) Pub. Date: Sep. 10, 2026

(54) AN LED MODULE

(71) Applicant: SIGNIFY HOLDING B.V., EINDHOVEN (NL)

(72) Inventor: CHUAN LIANG, JIANG SU (CN)

(21) Appl. No.: 19/160,885

(22) PCT Filed: Feb. 13, 2024
(86) PCT No.: PCT/EP2024/053549

§ 371 Date: Aug. 29, 2025

(30) Foreign Application Priority Data
Mar. 2, 2023 (WO) PCT/CN2023/079329
Jun. 19, 2023 (EP) 23180046.7

(51) Int. Cl. H05B 45/59; H05B 45/54

(52) U.S. Cl. CPC H05B 45/59; H05B 45/54

(57) ABSTRACT

An LED module comprising a string of LEDs (connected in series) that are effectively subdivided into a plurality of LED sub-strings by one or more intermediate nodes. Each LED is positioned proximate to a conductive surface, such that there a parasitic capacitance forms between each LED and the conductive surface. A biasing circuit applies a residual voltage, which exists when the LED string is operated in an off lighting state, to each intermediate node. The position of the intermediate node is selected such that the number of LEDs in each sub-string is less than or equal to a threshold, the LEDs less than or equal to such threshold is adapted to regulate LED conducting a current, in charging/discharging the parasitic capacitance(s), being a value unable for said at least one LED to emit light.

### FIELD OF THE INVENTION

The present invention relates to the field of lighting, and in particular to LED modules for use in a lighting arrangement.

### BACKGROUND OF THE INVENTION

The increasing use of artificial light is causing a greater demand for LED modules, e.g., for use in automobile applications.

In some use case scenarios, there is a desire to provide an LED module having a long string of LEDs, connected in series and powered by a same power supply. This may, for instance, be required for the emission of extremely bright light—such as high power indoor or outdoor lighting application, or may be desirable for an high power automobile headlight.

At the same time, there is a desire to provide a compact LED lighting arrangement. In such circumstances, it is common for the LEDs of an LED string to be in closer proximity to a conductive surface, which is itself coupled to a protective earth. In these scenarios, even when the LED module is set in an off lighting state, a residual voltage between the power provided to the LED module and the protective earth may exist since the LED driver may pass this residual voltage even when the switching has been stopped. This can cause parasitic current to flow through the LED string of the LED module, causing a glow effect. Some prior art documents, such as International Patent Application No. WO 2016/192987 A1, use a load switch in the LED driver to cut off the LED module from the LED driver. However, such a solution requires modifications to the LED driver, and are therefore less suited for retro-fit applications.

There is a desire to reduce or avoid the occurrence of LED glow, i.e., to avoid any LEDs of the LED string from emitting light when operating in the off lighting state. It would be preferable for this to be implemented on the LED module side, rather than the LED driver side, such that existing LED drivers can still be used.

### SUMMARY OF THE INVENTION

Some other prior art documents, such as German Patent Application No. DE 102016119448 A1, propose the use of shunt capacitors in parallel with each LED to bypass the parasitic current from the LED. However, one capacitor can normally cover (at most) two LEDs. Thus a large number of capacitors will be needed if the LED string has many LEDs. Thus the cost and complexity of such an implementation is very high.

The inventor has found that the root cause of the glow is that the parasitic current of forward biased LEDs also flows through any forward biased LEDs preceding itself in the series connection. Thus forward biased LED effectively accumulates its own parasitic current as well as other forward biased LED's parasitic currents later in the series connection. The forward biased LED would therefore emit light if this accumulated current is higher than the minimal current. The inventor has an insight that the ratio of the number of forward biased LEDs and the number of the reverse biased LEDs in an LED string will be relatively constant according to the forward volage and reverse voltage of LED, and that the number of forward biased LEDs is thus dependent on the total number of the LEDs in the string between the residual voltage and the reference potential. If the number of LEDs in a string is large, there are more LEDs that are forward biased and thus more parasitic currents to accumulate and turn an LED on. In view of this recognition, the inventor has proposed to effectively reduce the number of LEDs between the residual voltage and the reference potential. However, given that a long string of LEDs will have an already fixed number of LEDs, there remains the problem of how to reduce the number of LEDs between the residual voltage and the reference potential. The inventor further proposes to use a (or more) biasing circuit to apply the residual voltage to an (or more) intermediate node of the string of LEDs, thus the string of LEDs is effectively divided into two (or more) sub-strings each with a reduced number and each is applied with the residual voltage. In this way, the number of LEDs between the residual voltage and the reference potential is divided and can be lower than the threshold that would cause glow. Preferably, the biasing circuit would not interfere the normal driving voltage from the LED driver.

The invention is defined by the claims.

According to examples in accordance with an aspect of the invention, there is provided an LED module comprising: a string of LEDs connected in series, the string of LEDs being configured to, when operating in an off lighting state, receive a residual voltage with respect to a reference potential; an intermediate node located between two LEDs in the string of LEDs, the intermediate node thereby sub-dividing the string of LEDs into a first sub-string and a second sub-string; and a biasing circuit adapted to apply substantially the residual voltage to the intermediate node when the string of LEDs receives the residual voltage in the off lighting state.

At least some LEDs of the string of LEDs are adapted to be positioned proximate to a conductive surface, which is adapted to be coupled to the reference potential, such that a parasitic capacitance is formed between each of the at least some LEDs and the conductive surface thereby the reference potential. Each of the at least some LEDs is adapted to apply a parasitic current by the residual voltage and the reference potential via the parasitic capacitance when the string of LEDs is operating in an off lighting state.

The location of the intermediate node is configured such that the number of LEDs in the first and/or second sub-strings is below or at a threshold, the LEDs below or at which threshold, in the first and/or second sub-strings, is adapted to regulate, when the string of LEDs is operating in an off lighting state, any current, resulting from the parasitic current and flowing through any LED in each sub-string of LEDs in a forward bias direction, to be a value unable to cause any LED in each sub-string of LEDs to emit light.

In the above aspect of the invention, the intermediate node is designed at a location to split the LED string into two sub-strings and at least one sub-string or both sub-strings have a number of LEDs that is so small such that the parasitic currents of that sub-strings are not enough to cause any LED in that sub-string to emit light.

In some examples, LED is adapted to conduct the parasitic current of some other LEDs in the sub-string thereby the current flowing through the LED is an accumulation of the parasitic currents of its own and the some other LEDs, and the threshold is a function of a minimal current able to cause each LED to emit light and the parasitic current of the LEDs such that the accumulation of parasitic currents at the LEDs below or at the threshold is less than the minimal current of the LED.

Effectively, although the total parasitic currents are not reduced, they do not accumulate on a few LEDs but are distributed more evenly among the two sub-strings and not able to cause LED to emit light anymore.

The threshold may be a function of a first ratio of the minimal current and the parasitic current, and is sized such that a first number of forward biased LEDs, which is forward biased by the parasitic current, in the first and second sub-string is less or equal to the threshold which is a nearest integer to the first ratio that does not exceed the first ratio. This embodiment provides a mechanism for determining or selecting the number of LEDs to lie within each sub-string. This approach relies upon the recognition that the relationship between a parasitic current through an LED and the minimal current to cause an LED to emit light will influence how many LEDs can be forward biased in the sub-string before the accumulated parasitic current through an LED will exceed the minimal current, and in turn will influence totally how many LEDs are in the whole sub-string.

Each LED of the string of LEDs may comprise: a light emitting component with a forward voltage, wherein the parasitic current flowing through the LED in the forward bias direction flows through the lighting emitting component; and a protection component, connected in antiparallel with the light emitting component, having a reverse voltage wherein the parasitic current flowing through the LED in a reverse bias direction flows through the protection component. This embodiment provides a simple and reliable mechanism for providing an LED with a forward voltage and a reverse voltage, which may be less than the forward voltage. This is a widely used structure for LED.

The threshold may be responsive to the forward voltage and the reverse voltage and optionally responsive to a second ratio of the forward voltage to the reverse voltage.

In this embodiment, it shows that the forward biased LEDs and the reverse biased LEDs are depending on the forward voltage and the reverse voltage. Effectively, how many percentage of LEDs in the sub-string are forward biased is depending on the forward and reverse voltages. Thus the number of the LEDs in the sub-string should also consider the forward voltage and the reverse voltage so as to limit the number of the forward biased LEDs.

The sum of reverse voltages of a second number of the reverse biased LEDs may be adapted to balance a sum of the forward voltages of the first number of the forward biased LEDs, and the first number, under a condition of the number of LEDs in sub-string being less than the threshold, is less than the nearest integer thereby the parasitic current multiplied with the first number is less than the minimal current.

This embodiment defines that the sub-string should be that the forward biased LEDs in the sub-string balances with the remaining reverse biased LEDs via voltages, and forward biased LEDs should not be enough to cause sufficient parasitic current. The intermediate node should be positioned to provide such sub-string(s).

The protection component of each LED may be a transient voltage suppressor diode. This provides a reliable and cost-effective protection component for a light emitting diode.

Preferably, the forward voltage of each light emitting component is greater than the reverse voltage of each protection component, e.g., no less than 3 times greater than the reverse voltage of each protection component. As a working example, the forward voltage of each light emitting component may be substantially 2.8V, and the reverse voltage of each protection component may be substantially 0.7V.

In some examples, the biasing circuit comprises a first biasing component adapted to forward bias from a cathode end of the string of LEDs to the intermediate node. In such examples, when the residual voltage is positive with respect to the reference potential, the first biasing component may adapted to apply the residual voltage to the intermediate node when the string of LEDs is operating in an off lighting state, such that for the first sub-string, the forward biased LEDs are from (starting from) the anode of the string and the reverse biased LEDs are to (ending at) the intermediate node; and for the second sub-string, the forward biased LEDs are from (starting from) the intermediate node and the reverse biased LEDs are to (ending at) the cathode of the string.

This embodiment provides a specific implementation of the biasing circuit cope with the parasitic current/leakage in positive phase of the residual voltage.

The biasing circuit may comprise a second biasing component adapted to forward bias from the intermediate node to the anode end of the string of LEDs. In such examples, when the residual voltage is negative with respect to the reference potential, the second biasing component is adapted to apply the residual voltage to the intermediate node when the string of LEDs is operating in an off lighting state, such that for the first sub-string, the forward biased LEDs are to (starting from) the intermediate node and the reverse biased LEDs are from (ending at) the anode of the string; and for the second sub-string, the forward biased LEDs are to (ending at) the cathode of the string and the reverse bias LEDs are from (starting from) the intermediate node.

This embodiment provides a specific implementation of the biasing circuit cope with the parasitic current/leakage in negative phase of the residual voltage.

The number of LEDs in the LED string is preferably a value that, if the biasing circuit were decoupled and when the string of LEDs is operating in an off lighting state, the current, resulting from the parasitic current and flowing through one LED in each sub-string of LEDs in the forward bias direction, would be a value able to cause one LED in each sub-string of LEDs to emit light. Embodiments are particularly advantageous when employed to reduce a glow of an LED module that would otherwise glow since the total number of LEDs are too many. This embodiment is quite suitable for high power LED lighting with large number of LEDs.

The threshold for the number of LEDs in the first and/or second substring is from 3 to 60, preferably from 3 to 30, and even more preferably from 10 to 25. These examples provide thresholds for reduced glow that take account of existing LEDs and their properties. Those numeric ranges are determined according to practical values in reals implementations.

By way of example, the parasitic current is between 0.168 μA and 1.5 μA, preferably between 0.335 μA and 1.5 μA, and the value unable to cause any of the LEDs to emit light is below 2 μA and preferably below 1 μA. These values represent existing popular LEDs and their characteristics, as well as parasitic capacitance in popular LED lighting device, showing a particular working example of how the proposed approach can be employed with existing circuit components. Other values will be apparent to the skilled person and could, for instance, be derived from the technical datasheet for the relevant components.

In some examples, the LED module comprises a plurality of biasing circuits; and for each biasing circuit, a respective intermediate node. The LED module is configured such that, for each sub-string of LEDs between a pair of neighboring intermediate nodes, the number of LEDs in said sub-string is below or at the threshold such that when the string of LEDs is operating in an off lighting state, any current resulted from the parasitic current and flowing in a forward bias direction, through any LED in each sub-string of LEDs, is the value unable to cause any of said LEDs in each sub-string of LEDs to emit light.

This provides an approach in which the LED module is effectively sub-divided into more than two sub-strings, each of which are coupled between two nodes held at or near the residual voltage (when the string of LEDs operates in the off lighting state). This increases the possible maximum length of the LED string, e.g., such that the total length of the LED string can be arbitrary, without resulting in LED glow.

There is also provided an LED lighting appliance comprising: a power supply adapted to be connected to a line and a neutral of an AC mains input; and any herein proposed and described LED module, and the conductive surface adapted to connect a protective earth of the AC mains input as the reference potential.

The power supply may be adapted to be operable in: an on mode in which the power supply is configured to supply a drive voltage to the LED module to drive the string of LEDs such that they emit light; and an off mode in which the power supply cuts off the drive voltage, but passes the residual voltage of the AC mains input with respect to the protective earth to the LED module.

It will be appreciated that when the power supply operates in the off mode, so the string of LEDs operates in an off lighting state.

The LED lighting appliance may comprise a housing as the conductive surface by which the LED module is mounted close, and the housing is adapted to be connected to the protective earth.

The LED lighting appliance may be adapted wherein the LED module comprises a substate made of a conductive material, as the conductive surface, on which the LED module and the biasing component are mounted, wherein the substate is adapted to be connected to the protective earth.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates an existing LED module;

FIG. 2 illustrates a proposed LED module;

FIG. 3 illustrates the proposed LED module;

FIG. 4 illustrates another proposed LED module;

FIG. 5 illustrates the other proposed LED module; and

FIG. 6 illustrates an LED lighting arrangement.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides an LED module comprising a string of LEDs (connected in series) that are effectively subdivided into a plurality of LED sub-strings by one or more intermediate nodes. Each LED is positioned proximate to a conductive surface, such that there a parasitic capacitance forms between each LED and the conductive surface. A biasing circuit applies a residual voltage, which exists when the LED string is operated in an off lighting state, to each intermediate node. The position of the intermediate node is selected such that the number of LEDs in each sub-string is less than a threshold and is adapted to regulate LED conducting a current, in charging/discharging the parasitic capacitance(s), being a value unable for said at least one LED to emit light.

Embodiments are based on the realization that connecting a long string of LEDs between two ends held at a residual voltage can, if a residual voltage is applied to the two ends and there is a parasitic capacitance between each LED and a conductive surface (e.g., at a ground/reference potential) result in current flow through the LEDs and potential LED glow. In particular, it has been recognized that a smaller number of LEDs connected in series between two such nodes will not result in this LED glow.

Proposed approaches can be employed in any suitable lighting environment, but find particular advantage in automobiles (e.g., LED modules for use in automobile lighting), domestic lighting, industrial lighting, clinical lighting and so on.

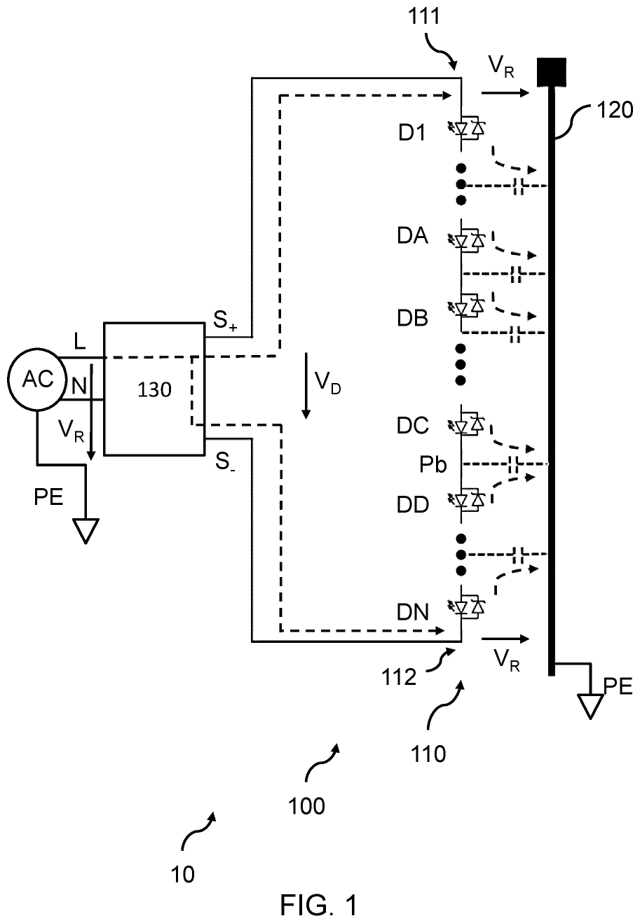

FIG. 1 illustrates an existing LED module 100 for improved contextual understanding.

The LED module 100 comprises a string 110 of LEDs D1, DA, DB, DC, DD, DN connected in series. It will be appreciated that the string 110 of LEDs has an anode end 111 and a cathode end 112.

Each LED has a light emitting component with a forward voltage; and a protection component, connected in antiparallel with the light emitting component, having a reverse voltage. The protection component of each LED may, for instance, be a transient voltage suppressor (TVS) diode.

The string of LEDs is positioned to be (physically) proximate to a conductive surface 120. The conductive surface is coupled to a reference potential PE, e.g., a ground or reference voltage. Thus, the voltage of the conductive surface is the same as the voltage of the reference potential. Due to the proximity between the string of LEDs and the conductive surface 120, a parasitic capacitance (conceptually illustrated with dashed lines) is therefore formed between each LED and the conductive surface.

The conductive surface 120 may, together with the LED module 100, form part of an LED lighting system 10.

The string of LEDs is driven by a power supply 130 which controls the voltage at a first drive node S₊ and a second drive node S₋ between which the string 110 of LEDs is connected. The power supply is connected to an AC mains power supply AC via line L and neutral N wires. The reference potential PE is also a reference potential PE of the AC mains power supply AC.

The power supply 130 may be adapted to be operable in an on mode in which the power supply is configured to supply a drive voltage V_{D} (where V_{D}=S₊−S₋≠0) to/across the LED module 110 to drive the string of LEDs such that they emit light. Thus, the drive voltage V_{D} provides a non-zero voltage difference between the anode end and the cathode end of the string of LEDs. Here “supply a drive voltage . . . to drive the string of LEDs” just means that when the power supply 130 drives the LED in either a current controlled manner or voltage controlled manner, a voltage is provided across the string of LEDs.

Similarly, the power supply may be operable in an off mode in which the power supply cuts off the drive voltage (i.e., V_{D}=0 or S₊=S₋). When the power supply operates in an off mode, the string of LEDs are expected to be in an off lighting state. In particular, the voltage difference between the anode end and the cathode end of the string of LEDs may be zero or negligible.

However, it has been herein recognized that, when operating in the off mode, the power supply may still pass a residual voltage of the AC mains input to the LED module through non-isolated component such as capacitors of the power supply as shown by the dashed line. This means the voltage at each drive node S₊ and S₋ equals to the AC mains voltage, especially to the line voltage. Thus, there may be a non-zero difference between the voltage provided to the LED module (e.g., the voltage at each drive node S₊ and S₋) and the voltage at the reference potential PE. The residual voltage V_{R} may be defined as:

$${V}_{R} = V ( {S}_{+} ) - V ( PE ) \qquad ( 1 )$$

$$or$$

$${V}_{R} = V ( {S}_{-} ) - V ( PE )$$

wherein V(S₊) is the voltage at the first drive node S₊, V(S₋) is the voltage at the second drive node S₋ and V(PE) is the voltage at the reference potential PE. The residual voltage V_{R} can be either positive or negative.

Due to the parasitic capacitances between each LED D1, DA, DB, DC, DD, DN and the conductive surface 120, changes in this voltage difference (e.g., due to fluctuations in the power supply, such as that inherent in an AC mains input) will cause current to flow through at least some of the LEDs. This can cause unwanted LED glow.

More particularly, if the AC mains voltage is at positive phase wherein the L wire is positive and the PE wire is negative (in case that the PE wire is connected to the N wire), at both of the first drive node and the second drive node and the voltage begins to rise (with respect to the voltage at the reference potential PE), then current will flow from the first drive node through a first set of the LEDs D1 to DC in the LED string 110, in a forward bias direction, to charge their parasitic capacitances, and will flow from the second drive node through a second set of the LEDs DD to DN in the LED string 110, in a reverse bias direction, to charge their parasitic capacitances.

More particularly, each LED will apply a parasitic current to its corresponding parasitic capacitances. This parasitic current is a charging current of its parasitic capacitance. As the LEDs are connected in series, these parasitic currents will accumulate, such that (during charging) a large accumulated current flows through the LED electrically closest to the anode end 111 of the LED string, with the value of the accumulated current reducing sequentially with each LED along the LED string away from the anode end 111.

By way of further explanation, as the voltage at the first drive node rises (with respect to the reference potential), current will begin to flow through the LED string in a forward bias direction (starting at the anode end). However, as the current flows through successive LEDs, some of the current flow through in the forward bias direction will be effectively siphoned off by each LED applying a parasitic current to charge its parasitic capacitor (following Kirchhoff's current law). This causes the current flow through each successive LED in the forward bias direction (starting at the anode end) to reduce along the forward bias direction. As the voltage at the second drive node rises (with respect to the reference potential), current will begin to flow through the LED string in a reverse bias direction (starting at the cathode end) and each successive LED in reverse bias direction starting at the cathode end. The volage will be balanced at a certain point Pb, a “first voltage balance point”, in the string. Thus, only the LEDs D1-DC above the point Pb in the LED string will conduct a parasitic current in the forward bias direction and only the LEDs DN to DD below the point Pb are reverse biased. Moreover, the conducted current in the forward bias direction will only be sufficiently high for the LEDs to emit light in a yet smaller subset of these LEDs, e.g., LEDs D1-DA close to the anode end. The forward biased LEDs and the reverse biased LEDs are determined by the forward voltage and the reverse voltages such that the voltage drop on the forward biased LEDs and the voltage drop on the reverse biased LED are substantially equal.

For example, the forward voltage could be 2.8V and the reverse voltage is 0.7V, thus the number of forward biased LED to the number of reverse biased LED should be 1:4. In case there are 20 LEDs in total, there should be 4 LEDs forward biased and the remaining 16 LEDs are reverse biased. Most notably, the parasitic current of DC must flow through the preceding forward biased LEDs D1, . . . , DA and DB in the series connection. So is the parasitic current of the LEDs DB, DA, and so on. Thus the LEDs at the anode end will accumulate a significant amount parasitic current. The current flow through each LED D1 to DC in the forward bias direction can be called an accumulated current. In a typical application, the parasitic current of each LED is 0.335 μA, and a minimum current to turn on one LED to emit light is just 1 uA, thus 3 LEDs' parasitic current is enough to turn on the first LED D1. In the above mentioned example of 20 LEDs, among the 4 forward biased LEDs, the first two D1 and DA may be turned on.

If AC mains voltage is at a negative phase, then the voltage at both the first drive node and the second drive node begins to fall (with respect to the voltage at the reference potential PE). Current will then flow from the parasitic capacitances through a third set of the LEDs in the LED string in a reverse bias direction, to discharge the parasitic capacitances and will flow through a fourth set of the LEDs in the LED string in a forward bias direction.

By way of further explanation, as the voltage at the first drive node falls (with respect to the reference potential), a parasitic current will begin to flow through the LED string in a reverse bias direction (ending at the anode end). As the parasitic current flows past successive LEDs, the magnitude of the current increases or accumulates with successive parasitic capacitances contributing to the accumulated current (following Kirchhoff's current law).

Similarly, as the voltage at the second drive node begins to fall (with respect to the voltage at the reference potential PE), then current will flow from the parasitic capacitances through a fourth set of the LEDs in the LED string in a forward bias direction, to discharge the parasitic capacitances. More particularly, parasitic current that flows in a forward bias direction will flow through the lighting emitting component of each LED in the fourth set.

As the voltage at the first drive node and the second drive node will follow each other, the volage will become balanced at a certain point, a “second voltage balance point”, (not shown) in the string. Thus, only the LEDs below this second voltage balance point in the LED string will conduct a parasitic current in the forward bias direction and only the LEDs above the point are reverse biased. Moreover, the conducted current in the forward bias direction will only be sufficiently high for the LEDs to emit light in a yet smaller subset of these LEDs, e.g., LEDs close to the second voltage balance point. As previously explained, the forward biased LEDs and the reverse biased LEDs are determined by the forward voltage and the reverse voltages such that the voltage drop on the forward biased LEDs and the voltage drop on the reverse biased LED are substantially equal.

By way of further explanation, as the voltage at the second drive node falls (with respect to the reference potential), a parasitic current will begin to flow through the LED string in a forward bias direction (ending at the cathode end). As the parasitic current flows through successive LEDs, the value of the current flow will increase or accumulate with successive parasitic capacitances contributing to the accumulated current. This causes the current flow through each successive LED in the forward bias direction (starting at the anode end) to increase along the forward bias direction. Only some of the LEDs DC-DN in the LED string will conduct a parasitic current in the forward bias direction. Moreover, the conducted current in the forward bias direction will only be sufficiently high for the LEDs to emit light in a yet smaller subset of these LEDs, e.g., LEDs DD-DN.

Therefore, if the voltage at the first and second drive nodes rises and falls, e.g., is sinusoidal, triangular or the like, then different subsets of LEDs will continue to glow alternately, e.g., the subset of LEDs D1-DA and DD-DN will alternatively glow. Thus, there is a first subset D1-DA and a second subset DD-DN through which parasitic current will flow.

The present disclosure recognizes that if the number of LEDs in the LED string 110 is too large, then the magnitude of an accumulated current flow through one or more of the LEDs in a forward bias direction will be sufficiently large to cause the one or more LEDs to emit light. This is because any current flow in the reverse bias direction will become insufficient to charge or discharge the parasitic capacitance with the associated one or more LEDs.

The present disclosure provides a mechanism to reduce the effect of any parasitic current, to thereby reduce light emission when the power supply in operating in an off-state, i.e., to reduce LED glow.

In the above mentioned example, for a LED string of 20 LEDs, there are four LEDs forward biased, and two of them are turned on. Conceptually, if the number of the LEDs across the residual voltage can be reduced to only 15, the number of LEDs that are forward biased will reduce (e.g., to 3), and the number of LEDs that can pass enough parasitic current to glow will similarly be reduced, e.g., to only one LED of three forward biased LEDs. More preferably, if the number of LEDs across the residual voltage can be further reduced to 10, the number of LEDs that are forward biased may further reduce (e.g., to 2), and the number of LEDs that can pass enough parasitic current to glow may also be reduced, e.g., to 0, such that it is possible to completely avoid the glow.

It is herein proposed to provide the residual voltage at one or more intermediate locations between the anode end and the cathode end of the LED string. This effectively splits the LED string into a series of sub-strings, where each sub-string is connected between two nodes held at the residual voltage (or at a voltage near the residual voltage with a minor voltage drop). The number of LEDs in each sub-string is configured such that a current flow (particularly a current flow in the forward bias direction) through any LED of each sub-string resulting from the parasitic current or an accumulated parasitic current is insufficient to cause any LED to emit light. Thus, LED glow is avoided/reduced.

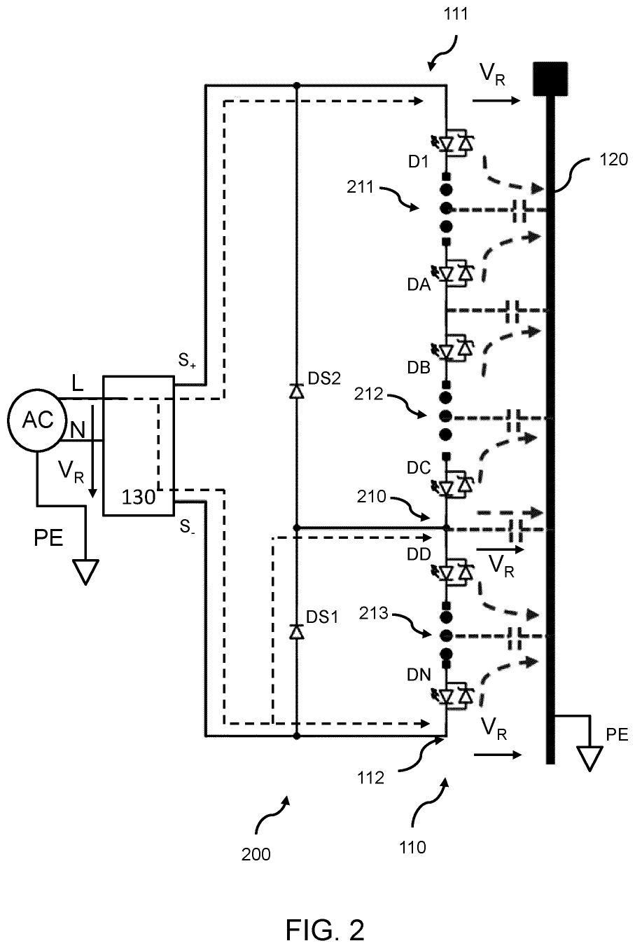

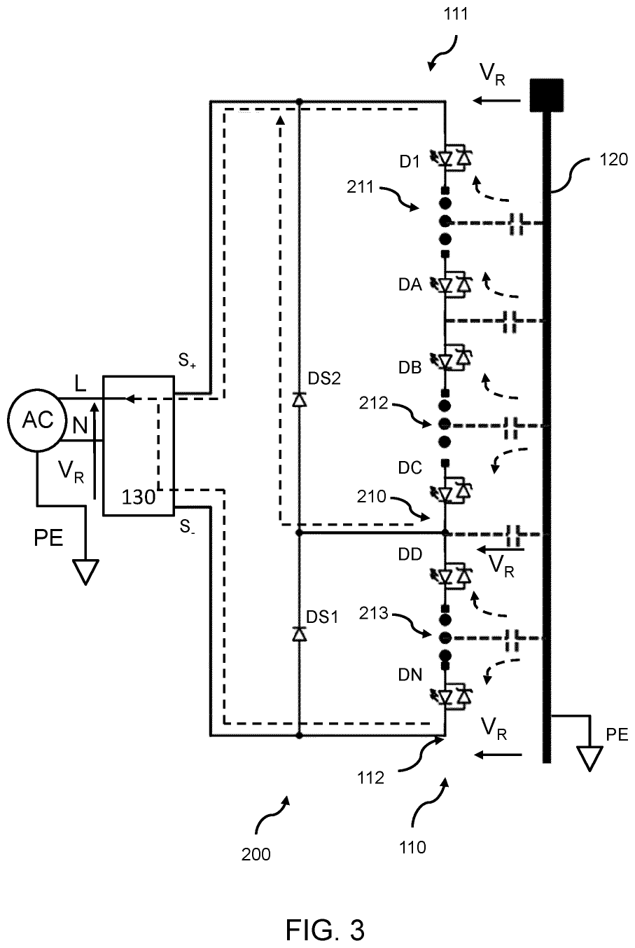

FIGS. 2 and 3 illustrate an LED module 200 according to an embodiment.

Compared to the previously described LED module, the LED module 200 further comprises a biasing circuit DS1, DS2. The biasing circuit DS1, DS2 is adapted to apply (substantially) the residual voltage to an intermediate node 210 in the string of LEDs when the string of LEDs receives the residual voltage in the off lighting state.

In other words, the biasing circuit DS1, DS2 applies the residual voltage, or a voltage near the residual voltage (minus any voltage drop of the biasing circuit), to an intermediate node 210 when the power supply 130 is operating in an off mode, but still provides a residual voltage (V_{R}≠0) to the string of LEDs.

The intermediate node 210 is a node located between two LEDs in the string of LEDs. The intermediate node thereby sub-divides the string of LEDs into a first sub-string D1-DC and a second sub-string DD-DN.

More particularly, the intermediate node is located such that the number of LEDs in each sub-string is such that a current flow (in the forward bias direction) through any LED of each sub-string is insufficient to cause any LED of that sub-string to emit light, when the string of LEDs is operating in the off lighting state, e.g., when the parasitic capacitances are charging and/or discharging via the residual voltage.

This is achieved by setting the location of the intermediate node such that the number of LEDs in each sub-string is reduced. With the ratio of number of forward biased LEDs and the number of reverse biased LEDs being unchanged (as the forward voltage and the reverse voltage of each LED will remain unchanged), the reduced total number effectively reduces the number of the forward biased LEDs and the number of parasitic currents that are accumulated at the front LEDs (i.e., the LEDs close to the anode end of each LED sub-string). This causes the effective accumulated parasitic current to be insufficient to cause the LED conducting said current to emit light. For each sub-string, the reverse bias current flow through the LED string (via the protection components) contributes to the charging or discharging of each parasitic capacitance to the extent that the current flow in a forward bias direction through any light emitting element is insufficient to cause said forward biased light emitting element to emit light.

The more LEDs that are formed in a string or sub-string between two nodes held at a residual voltage, the greater the current flow in a forward bias direction: 1) through the LED nearest the anode end of the (sub-)string when a positive phase of residual voltage charging the parasitic capacitance and 2) through the LED nearest the cathode end of the (sub-)string when the parasitic capacitance discharges with a negative phase of residual voltage.

Through appropriate selection of the location of the intermediate node, which defines the number of LEDs in the first and second sub-strings, the number of LEDs that are connected in series in each sub-string can be controlled to be below a critical value that avoids the current flow through any LED in a forward bias direction (e.g., the accumulated current) rising above a value sufficient to cause any LED in said sub-string to emit light.

FIG. 2 illustrates the case when the positive phase of the AC mains occurs. A first biasing component DS1 of the biasing circuit DS1 acts to split the whole LED string into two sub-string.

During charging (positive phase), for the first sub-string D1 to DC, parasitic current flow in a forward bias direction will occur only in forward biased LEDs D1. A single parasitic current through the forward biased LED D1 is not enough to cause said LED to emit light. Parasitic current flow in a reverse bias direction will occur only in the remaining reverse biased LEDs DB to DC which does not flow through the light emitting component, such that these LEDs will not emit light either.

Similarly, for the second sub-string DD to DN, current flow in a forward bias direction will occur only in a forward biased LED DD. A single parasitic current through the forward biased LED DD is not enough to cause said LED to emit light. Parasitic current flow in a reverse bias direction will occur only in the remaining reverse biased LEDs DN which does not flow through the light emitting component of said LEDs, such that these LEDs will not emit light either.

FIG. 3 shows the case when the negative phase of the AC mains occurs and the biasing circuit DS2 act to split the whole LED string into two sub-string.

During negative phase, for the first sub-string D1 to DC, parasitic current flow in a forward bias direction will occur only in forward biased LEDs DC since only the forward voltage of LED DC balance with the reverse voltages of the remaining LEDs. A single parasitic current through the forward biased LED DC is not enough to cause said LED to emit light. Parasitic current flow in a reverse bias direction will occur only in the remaining reverse biased LEDs D1 to DB which does not flow through the light emitting component, such that these LEDs will not emit light either.

Similarly, for the second sub-string DD to DN, current flow in a forward bias direction will occur only in a forward biased LED DN since only the forward voltage of LED DN balance with the reverse voltages of the remaining LEDs. A single parasitic current through the forward biased LED DN is not enough to cause said LED to emit light. Parasitic current flow in a reverse bias direction will occur only in the remaining reverse biased LEDs DD which does not flow through the light emitting component of said LEDs, such that these LEDs will not emit light either.

It will be appreciated that the greater the number of LEDs in any sub-string (or subset), the greater the chance of one of the LEDs in the sub-string (or subset) emitting light during an off lighting state. This is because, the larger the number of LEDs in any sub-string, the more LEDs will conduct in a forward bias direction during charging/discharging of the parasitic capacitances (i.e., the more LEDs in any subset), meaning the more likely that an LED closer to a node held at the residual voltage (at the anode end, the cathode end or the intermediate node) will conduct a current in a forward bias direction that has a value sufficient to cause the LED to emit light.

The present invention acts to reduce the number of LEDs connected in series between two nodes/points held at the residual voltage. This reduces the number of LEDs that will conduct a current in a forward bias direction during charging/discharging of any parasitic capacitance, as well as the largest value of the forward bias current through any LED during such times.

In the present invention, the location of the intermediate node is configured such that the number LEDS in each sub-string is below or at a threshold. The threshold is a number that results in a current flow, resulting from the parasitic current, through any LED in the sub-string in a forward bias direction to be less than a threshold current that would cause an LED to emit light. In particular, numbers greater than the threshold would result in a current flow through at least one LED in the sub-string in a forward bias direction to be greater than a threshold current that would cause said at least one LED to emit light.

In some examples, the threshold is responsive to a ratio between the value of the current required to cause any LED in the string of LEDs to emit light and the value of the parasitic current applied by a single LED (to its parasitic capacitance) in the string of LEDs. It has been recognized that this ratio defines how many LEDs can be connected in series before an accumulation of the parasitic currents will exceeds the threshold current and cause an LED to emit light.

In a particular example, the threshold may be the nearest integer to the ratio that does not exceed the ratio; and the number of LEDs in each sub-set of LEDs may be no greater than this threshold, e.g., equal to this threshold.

In a more nuanced example, assuming that each LED is essentially identical in structure and construction, one approach for determining the threshold N_{T} is as follows:

$${N}_{T} = ⌊ \frac{{I}_{L EDMIN}}{{I}_{cap}} \cdot ( 1 + \frac{{V}_{F}}{{V}_{PC}} ) ⌋ \qquad ( 2 )$$

where: I_{LEDMIN} is the minimum required current through an LED in a forward bias direction for said LED to emit light, I_{cap} is the charging current of each parasitic capacitance; V_{F} is the forward voltage of each LED and V_{PC} is the reverse voltage (i.e., the voltage drop) across the LED (e.g., the protective component) when it conducts current in a reverse bias direction. The function └.┘ represents a flooring function, that identifies the nearest integer below the value bound by the function.

The principle behind this formula that given the total number of LEDs is N_{T}, the number n1 of forward biased LEDs multiplied with the forward voltage V_{F} equals to the number n2 of reverse biased LEDs multiplied with the reverse voltage V_{PC}, and the sum of the number n1 of forward biased LEDs and the number n2 of the reverse biased LEDs are the total number N_{T} (i.e., N_{T}=n1+n2). This leads to the number n1 of the forward biased LED is

$${N}_{T} \times \frac{{V}_{PC}}{{V}_{F} + {V}_{PC}} .$$

The maximum accumulation of parasitic currents at the first forward biased LED is

$${N}_{T} \times \frac{{V}_{PC}}{{V}_{F} + {V}_{PC}} \times {I}_{cap} .$$

The maximum accumulation of parasitic currents

$${N}_{T} \times \frac{{V}_{PC}}{{V}_{F} + {V}_{PC}} \times {I}_{cap}$$

should be at most equal to the I_{LEDMIN} minimum required current to emit light, namely

$${N}_{T} \times \frac{{V}_{PC}}{{V}_{F} + {V}_{PC}} \times {I}_{cap} = {I}_{LEDMIN} .$$

This equation leads to the above formula (2).

Another approach to determining the position for the intermediate node is to make use of one or more voltage balance nodes.

Looking at FIG. 2, it is possible to define a first voltage balance node 211, which is a node, between the anode end 111 and the intermediate node 210, where the difference between the sum of the forward voltages of LEDs between the anode end 111 and the first voltage balance node 211 and the sum of the reverse voltages of the remaining of the LEDs in the first sub-string is minimum/less than if the first voltage balance node were positioned anywhere else.

Preferably, the number of LEDs in the first substring is configured (though appropriate selection of the position of the intermediate node) such that the number of LEDs between the anode end and the first voltage balance node, which is effectively the number of forward biased LEDs, is less than the ratio between the value of the current required to cause any LED in the string of LEDs to emit light and the value of the parasitic current applied by a single LED (to its parasitic capacitance) in the string of LEDs. Thus the forward biased LEDs can not allow an enough accumulation of parasitic currents to emit light.

This technique will prevent any LED in the first substring from emitting light during charging of the parasitic capacitances (when the LED module operates in an off lighting state).

Turning to FIG. 3 particularly, for the negative phase situation and the biasing circuit DS2 acting, it is possible to define a second voltage balance node 212, which is a node, between the anode end 111 and the intermediate node 210, where the difference between the sum of the forward voltages of LEDs between the second voltage balance node 212 and the intermediate node 210 and the sum of the reverse voltages of the remaining of the LEDs in the first sub-string is less than if the second voltage balance node were positioned anywhere else.

Preferably, the number of LEDs in the first substring is configured such that the number of LEDs between the second voltage balance node 212 and the intermediate node 210 is less than the ratio between the value of the current required to cause any LED in the string of LEDs to emit light and the value of the parasitic current applied by a single LED (to its parasitic capacitance) in the string of LEDs.

This technique will prevent any LED in the first substring from emitting light during discharging of the parasitic capacitances (when the LED module operates in an off lighting state).

Go back to FIG. 2, for the second sub-string, it is possible to define a third voltage balance node 213, which is a node, between the intermediate node 210 and the cathode end 112, where the difference between the sum of the forward voltages of LEDs between the intermediate node 210 and the third voltage balance node 213 and the sum of the reverse voltages of the remaining of the LEDs in the second sub-string is less than if the third voltage balance node were positioned anywhere else.

Preferably, the number of LEDs in the second substring is configured (though appropriate selection of the position of the intermediate node) such that the number of LEDs between the intermediate node 210 and the third voltage balance node is less than the ratio between the value of the current required to cause any LED in the string of LEDs to emit light and the value of the parasitic current applied by a single LED (to its parasitic capacitance) in the string of LEDs.

This technique will prevent any LED in the second substring from emitting light during charging of the parasitic capacitances (when the LED module operates in an off lighting state).

Turning back again to FIG. 3, it is possible to define a fourth voltage balance node 214, which is a node, between the intermediate node 210 and the cathode end 112, where the difference between the sum of the forward voltages of LEDs between the fourth voltage balance node 214 and the intermediate node 210 and the sum of the reverse voltages of the remaining of the LEDs in the first sub-string is less than if the second voltage balance node were positioned anywhere else.

Preferably, the number of LEDs in the second substring is configured (though appropriate selection of the position of the intermediate node) such that the number of LEDs between the fourth voltage balance node 212 and the cathode end 112 is less than the ratio between the value of the current required to cause any LED in the string of LEDs to emit light and the value of the parasitic current applied by a single LED (to its parasitic capacitance) in the string of LEDs.

This technique will prevent any LED in the second substring from emitting light during discharging of the parasitic capacitances (when the LED module operates in an off lighting state).

Preferably, the position of the intermediate node is selected so that all of the above-mentioned preferences for the voltage balance nodes are taken into account. This will cause the LED module to be adapted to regulate, when the string of LEDs is operating in an off lighting state, any current flowing in a forward bias direction, through any LED in each sub-string of LEDs, to be below a value sufficient to cause any of said LEDs in each sub-string of LEDs to emit light.

In the illustrated example, the biasing circuit comprises a first biasing component DS1 adapted to connect from a cathode end of the string of LEDs to the intermediate node; and when the residual voltage is positive with respect to the reference potential, the first biasing component is adapted to apply the residual voltage to the intermediate node such that the parasitic current flow through any LED that is forward biased by the residual voltage to the reference potential is insufficient to cause any of the LEDs in the set of LEDs to emit light.

The first biasing component DS1 takes the form of a diode.

In the illustrated example, there is provided a second biasing component DS2 that is adapted to connect from an anode end of the string of LEDs to the intermediate node. When the residual voltage is negative with respect to the reference potential, the second biasing component applies the residual voltage to the intermediate node 210. This performs a similar function to the first biasing component (which applies the residual voltage it is positive). FIG. 3 shows the forward biased LEDs and the reverse biased LED, as well as their respective parasitic currents.

The second biasing component DS2 takes the form of a diode.

It will be appreciated that proposed embodiments are particularly advantageous when the number of LEDs in the LED string is a value that, if the biasing circuit were decoupled and when the string of LEDs is operating in an off lighting state, a current flowing in a forward bias direction, through at least one LED in would be above a value sufficient to cause said at least one LED. For example, as described in the above mentioned example, a total number of 15 has been sufficient to cause glow.

By way of example only, the number of LEDs in each of the first and second substrings is between 3 to 60, preferably 3 to 30, and even more preferably 10 to 25. The exact number may vary according to the minimal current to turn on the LED, the parasitic current of each LED, as well as the forward voltage and the reverse voltage. For example, if the minimal current to turn on the LED is large, it requires more forward biased LED thus the number of LEDs of the substring can be large. If the parasitic current of each LED is large, it requires less forward biased LEDs for the current through one of said LEDs (resulting from the accumulated current) to reach the minimal current (to turn it on), thus the number of LEDs of the substring should be small. If the forward voltage is high, a lower percentage of the LEDs in the sub-string will be forward biased, thus the number of LEDs of the sub-string can be greater. If the reverse voltage is high, a greater percentage of LEDs of the sub-string is forward biased, thus the number of LEDs of the sub-string should be less.

The charging current of each parasitic capacitor (i.e., the parasitic current) depends on the parasitic capacitance as well as the normal amplitude of residual voltage. The value of the parasitic capacitance will depend on the area of the conductive pad (e.g., copper pad) of the LED, the distance between the LED (conductive/copper pad) and the conductive surface, as well as the di-electric constant of an insulation material between the LED and the conductive surface. In real implementations, the copper pad area may be 40-200 mm² for each LED; the parasitic capacitance of each LED may be 15-75 pF; and the value of the parasitic current may be between 0.168 ∪A (for an extra small copper pad area) to 1.5 ∪A, preferably 0.335 μA (for an ordinary copper pad area) to 1.5 μA.

The value sufficient to cause any of the LEDs in the subset of LEDs to emit light may be 1 μA to 2 μA. Other suitable example values will be apparent to the skilled person and may depend upon the precise characteristics of the LEDs, as would be derivable from the technical datasheet for the LED.

The forward voltage of each LED may, for instance, be around 2.8V. A reverse voltage of each LED may be around substantially 0.7V. These values represent typical or common values but other values are also possible, and are similarly derivable from the technical datasheet for the LED.

In the above embodiments, two biasing components are used to provide the residual voltage to a single intermediate node, wherein each biasing component is used for handling the parasitic currents for one phase of the residual voltage. However, other embodiments are also possible. In a simplified embodiment, there could be only a single biasing component circuit for handling only the parasitic currents for a single (i.e., one) phase of the residual voltage; whereas the parasitic currents in the other phase may be tolerated by the user since the glow has been reduced by half.

Alternatively, in case that only one intermediate node is insufficient, embodiments may provide a plurality of biasing circuits with a respective plurality of intermediate nodes.

Thus, in some embodiments, there is provided a plurality of biasing circuits; and for each biasing circuit, a respective intermediate node within the string of LEDs.

The LED module is configured such that each sub-string of LEDs between a pair of neighboring intermediate nodes is adapted to comprise a number of LEDs below the threshold and is adapted to regulate the accumulated current resulted from the parasitic current through any LED in the sub-string to be a value unable to cause any of the LEDs in the subset of LEDs to emit light.

In the embodiment illustrated by FIGS. 2 and 3, there are two biasing components DS1, DS2 (forming a single biasing circuit) and one intermediate node 210 which makes the number of LEDs in each sub-string below the threshold. However, it could be that the LED string is very long and one intermediate node is not enough to ensure each sub-string has the proper number of LEDs.

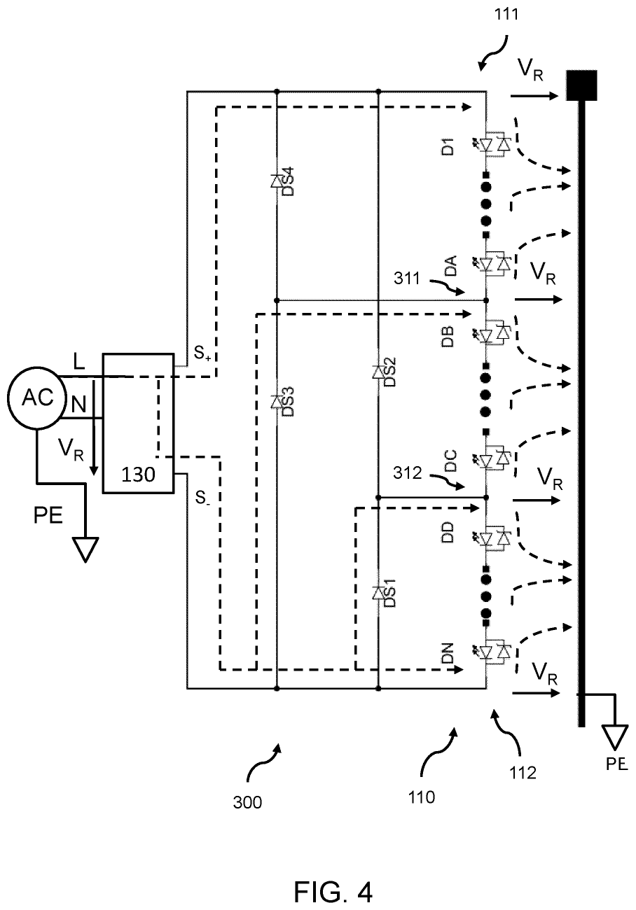

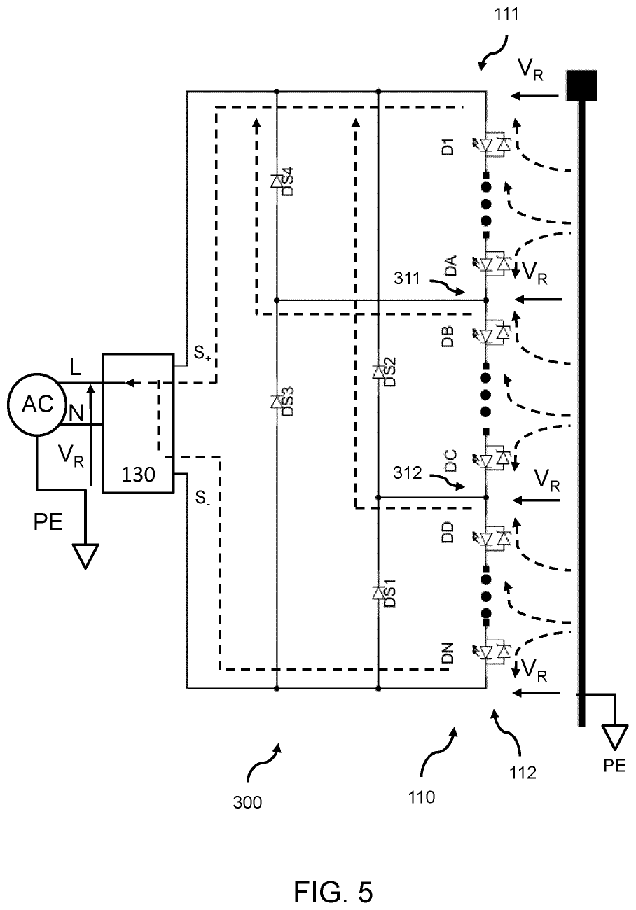

FIGS. 4 and 5 illustrate an example of a further embodiment of an LED module 300 with more than one intermediate node such that the number of LED between each neighboring intermediate nodes has the proper number.

The LED module 300 comprises a plurality of biasing circuits DS1, DS2, DS3, DS4, namely a first biasing circuit DS1, DS2 and a second biasing circuit DS3, DS4. For example, the biasing circuit DS1, DS2 is able to provide a sub-string of LEDs DD to DN less than the threshold, but the LEDs D1 to DC are still too many LEDs and may generate large parasitic current to turn on the LEDs D1. Thus, the second biasing circuit DS3, DS4 is used. The two biasing circuits sub-divide the LED string 110 into three sub-strings instead of only two. The two biasing circuit thereby define two intermediate nodes (a first 311 and second 312 intermediate node) between the anode end 111 and the cathode end 112 of the LED string 110. In particular, there is a first substring (between the anode end 111 and a first intermediate node 311); a second substring (between the first intermediate node 311 and a second intermediate node 312) and a third substring (between the second intermediate node 312 and the cathode end 112). Each biasing circuit applies the residual voltage when the string of LEDs is operating in the off lighting state (e.g., minus a small voltage drop) to a respective intermediate node 311, 312. In this way, each substring is connected between two nodes held at the residual voltage.

The number of LEDs in each sub-string is controlled such that the number of LEDs in said sub-string is below or at a threshold such that when the string of LEDs is operating in an off lighting state, any current flowing in a forward bias direction, through any LED in each sub-string of LEDs, is below a value sufficient to cause any of said LEDs in each sub-string of LEDs to emit light.

As shown in FIG. 4, during a positive charging phase of the parasitic capacitances, only the LEDs D1, DB and DD in the sub-strings are forward biased and the parasitic current in each sub-string is so small that unable to make the forward biased LEDs to emit light.

A similar principle described with respect to the embodiment illustrated by FIGS. 2 and 3 applies to the embodiment illustrated by FIGS. 4 and 5. Basically, for each sub-string, the number of the forward biased LEDs is so small that the accumulated parasitic currents are not enough for any forward biased LED in the sub-string to emit light, for both the positive phase and the negative phase of the residual voltage.

FIG. 5 shows the parasitic currents when the residual voltage is negative phase. The biasing circuits DS2 and DS4 are used for applying the residual voltage onto the intermediate nodes such that there is only a very few LEDs DA, DC and DN are forward biased in the sub-strings and that the parasitic current in each sub-string are so small and unable to reach a value sufficient to cause the forward biased LEDs to emit light.

Although the less number in each sub-string the better, it is not economical to provide so many biasing circuits, thus the most cost-effective way is providing the intermediate nodes to just split whole string into the sub-strings each whose LED number is just at the critical value: it would not emit light but just one more LED would emit light. Or, to provide enough margin, the LED number in each sub-string can be set to be one or two less than the critical value.

There is also provided an LED lighting appliance comprising: a power supply adapted to be connected to an AC mains input; and any previously described LED module. The LED lighting appliance may also comprise a conductive surface adapted to connect a protective earth of the AC mains input as the reference potential.

Examples of suitable power supplies have been previously described. In particular, the power supply is adapted to be operable in: an on mode in which the power supply is configured to supply a drive voltage to the LED module to drive the string of LEDs such that they emit light; and an off mode in which the power supply cuts off the drive voltage, but passes the residual voltage of the AC mains input to the LED module. Such a power supply is typically a non-isolated power converter such as buck, boost, and buck-boost. An isolated converter, such as flyback converter, with an Y-capacitor connected across the isolation may also pass the residual voltage to the LED module in a turn off state thus can also be taken as the power supply and be handled by the embodiment of the application to prevent glow.

The LED lighting appliance may comprise a housing as the conductive surface by which the LED module is mounted close.

The housing may be adapted to be connected to the protective earth.

In some other examples, the LED module comprises a substate made of a conductive material, as the conductive surface, on which the LED module and the biasing component are mounted, wherein the substate is adapted to be connected to the protective earth. Such a substate may be the metal core of the LED PCB.

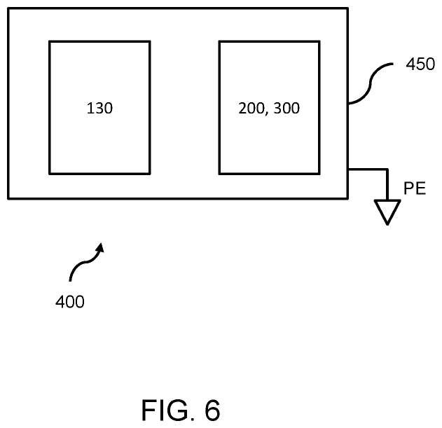

FIG. 6 conceptually illustrates an example of an LED lighting appliance 400. The LED lighting appliance here comprises a power supply 130, an LED module 200, 300 and a housing 450 (which houses the power supply and the LED module 200, 300). The housing 450 is connected to the protective earth and acts as the conductive surface to which the LED module is closely mounted.

Preferably, any herein described LED module or LED lighting arrangement is configured for use in an automobile, e.g., in a headlight, side light and/or signaling light of an automobile. Thus, there are proposed automobile LED modules and/or LED lighting arrangements.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A LED module comprising:
a string of LEDs connected in series, the string of LEDs being configured to, when operating in an off lighting state, receive a residual voltage with respect to a reference potential,
wherein at least some LEDs of the string of LEDs are adapted to be positioned proximate to a conductive surface which is adapted to be coupled to the reference potential, such that a parasitic capacitance is formed between each of the at least some LEDs and the conductive surface thereby the reference potential, wherein each of the at least some LEDs is adapted to apply a parasitic current by the residual voltage and the reference potential via the parasitic capacitance;
an intermediate node located between two LEDs in the string of LEDs, the intermediate node thereby sub-dividing the string of LEDs into a first sub-string and a second sub-string; and
a biasing circuit adapted to apply substantially the residual voltage to the intermediate node, wherein:
the location of the intermediate node is configured such that the number of LEDs in the first and/or second sub-strings is below or at a threshold, said number of the LEDs below or at said threshold in the first and/or second sub-strings is adapted to regulate any current, resulting from the parasitic current and flowing through any LED in each sub-string of LEDs in a forward bias direction, to be a value unable to cause any LED in each sub-string of LEDs to emit light.

2. The LED module of claim 1, wherein each LED is adapted to conduct the parasitic current of the at least some other LEDs in the sub-string thereby the current flowing through the LED is an accumulation of the parasitic currents of its own and the at least some other LEDs, and
the threshold is set according to a minimal current able to cause each LED to emit light, and the parasitic current of the LEDs, such that the accumulation of the parasitic currents of its own and the at least some other LEDs is less than the minimal current of the LED.

3. The LED module of claim 2, wherein the threshold is set to value as the nearest integer lower than a first ratio, whereby the first ratio of the minimal current and the parasitic current, such that a first number of forward biased LEDs, which is forward biased by the parasitic current, in the first and second sub-string is less or equal to the first ratio.

4. The LED module of claim 3, wherein each LED of the string of LEDs comprises:
a light emitting component with a forward voltage, wherein the parasitic current flowing through the LED in the forward bias direction flows through the lighting emitting component; and
a protection component, connected in antiparallel with the light emitting component, having a reverse voltage wherein the parasitic current flowing through the LED in a reverse bias direction flows through the protection component.

5. The LED module of claim 4, wherein the threshold is responsive to the forward voltage and the reverse voltage and optionally responsive to a second ratio of the forward voltage to the reverse voltage, and
a sum of reverse voltages of a second number of the reverse biased LEDs is adapted to balance a sum of the forward voltages of the first number of the forward biased LEDs, and
the first number, under a condition of the number of LEDs in sub-string being less than the threshold, is less than the nearest integer thereby the parasitic current multiplied with the first number is less than the minimal current.

6. The LED module of claim 4, wherein the protection component of each LED is a transient voltage suppressor diode.

7. The LED module of claim 5, wherein the forward voltage of each light emitting component is substantially 2.8V, and the reverse voltage of each protection component is substantially 0.7V.

8. The LED module of claim 1, wherein:
the biasing circuit comprises a first biasing component adapted to forward bias from a cathode end of the string of LEDs to the intermediate node; and
when the residual voltage is positive with respect to the reference potential, the first biasing component is adapted to apply the residual voltage to the intermediate node when the string of LEDs is operating in an off lighting state, such that
for the first sub-string, the forward biased LEDs are from the anode of the string and the reverse biased LEDs are to the intermediate node; and
for the second sub-string, the forward biased LEDs are from the intermediate node and the reverse biased LEDs are to the cathode of the string.

9. The LED module of claim 1, wherein:
the biasing circuit comprises a second biasing component adapted to forward bias from the intermediate node to the anode end of the string of LEDs; and
when the residual voltage is negative with respect to the reference potential, the second biasing component is adapted to apply the residual voltage to the intermediate node when the string of LEDs is operating in an off lighting state, such that
for the first sub-string, the forward biased LEDs are to the intermediate node and the reverse biased LEDs are from the anode of the string; and
for the second sub-string, the forward biased LEDs are to the cathode of the string and the reverse bias LEDs are from the intermediate node.

10. The LED module of claim 1, wherein the number of LEDs in the LED string is a value that, if the biasing circuit were decoupled and when the string of LEDs is operating in an off lighting state, the current, resulting from the parasitic current and flowing through one LED in each sub-string of LEDs in the forward bias direction, would be a value able to cause one LED in each sub-string of LEDs to emit light.

11. The LED module of claim 1, wherein the threshold for the number of LEDs in the first and/or second substring is from 3 to 60.

12. The LED module of claim 1, wherein the parasitic current is between 0.168 μA and 1.5 μA, and the value unable to cause any of the LEDs to emit light is below 2 μA.

13. The LED module of claim 1, comprising:
a plurality of biasing circuits; and
for each biasing circuit, a respective intermediate node,
wherein the LED module is configured such that, for each sub-string of LEDs between a pair of neighboring intermediate nodes, the number of LEDs in said sub-string is below or at the threshold such that when the string of LEDs is operating in an off lighting state, any current resulted from the parasitic current and flowing in a forward bias direction, through any LED in each sub-string of LEDs, is the value unable to cause any of said LEDs in each sub-string of LEDs to emit light.

14. An LED lighting appliance comprising:
a power supply adapted to be connected to a line and a neutral of an AC mains input; and
the LED module according to claim 1, and
the conductive surface adapted to connect a protective earth of the AC mains input as the reference potential,
wherein the power supply is adapted to be operable in:
an on mode in which the power supply is configured to supply a drive voltage to the LED module to drive the string of LEDs such that they emit light; and
an off mode in which the power supply is configured to cut off the drive voltage, but to pass the residual voltage of the AC mains input with respect to the protective earth to the LED module.

15. The LED lighting appliance of claim 14, comprising a housing as the conductive surface by which the LED module is mounted close, and the housing is adapted to be connected to the protective earth; and/or
the LED module comprises a substate made of a conductive material, as the conductive surface, on which the LED module and the biasing component are mounted, wherein the substate is adapted to be connected to the protective earth.
